(19) United States
(12) Patent Application Publication
(10) Pub. No.: US 2026/0110786 A1
(43) Pub. Date: Apr. 23, 2026

(54) CONTROL SYSTEM AND CONTROL METHOD

(71) Applicant: Nuvoton Technology Corporation Japan, Kyoto (JP)

(72) Inventor: Tomohito NAGATA, Kyoto (JP)

(21) Appl. No.: 19/424,321

(22) Filed: Dec. 18, 2025

Related U.S. Application Data
(63) Continuation of application No. PCT/JP2024/023917, filed on Jul. 2, 2024.
(60) Provisional application No. 63/512,000, filed on Jul. 5, 2023.

(51) Int. Cl. G01S 7/497

(52) U.S. Cl. CPC G01S 7/497

(57) ABSTRACT

A control system is included in each of sensors in a detection system that detects an object by using the sensors. The control system includes a counter, a first obtainer, a second obtainer, and a processing section. The counter generates an operation signal for causing a corresponding one of the sensors to operate in accordance with a counter value. The first obtainer obtains time information shared among the sensors. The second obtainer obtains the counter value of the counter at a time point when the first obtainer obtains the time information. Based on the time information obtained by the first obtainer and the counter value obtained by the second obtainer, the processing section performs adjustment processing for adjusting a timing at which an operation signal is generated.

### CROSS REFERENCE TO RELATED APPLICATION

This is a continuation application of PCT International Patent Application No. PCT/JP2024/023917 filed on Jul. 2, 2024, designating the United States of America, which is based on and claims priority of U.S. Provisional Patent Application No. 63/512000 filed on Jul. 5, 2023. The entire disclosures of the above-identified applications, including the specifications, drawings and claims are incorporated herein by reference in their entirety.

### FIELD

The present disclosure relates to a control system and a control method.

### BACKGROUND

For example, Patent Literature (PTL) 1 discloses a ranging device. This ranging device includes: a light emitter that irradiates an object with irradiation light; a light receiver that receives reflected light from the object; a distance calculator that calculates, from an output signal of the light receiver, a distance to the object; and a controller that controls the light emitter and the light receiver to determine, based on a distance calculation result by the distance calculator, whether interference from another ranging device is present or not.

### CITATION LIST

### Patent Literature [PTL 1] Japanese Unexamined Patent Application Publication No. 2021-60246

### SUMMARY

### Technical Problem

The present disclosure provides a control system or the like that can adjust the operation timing of a sensor without wiring a signal line for timing adjustment.

### Solution to Problem

A control system according to an aspect of the present disclosure is a control system that is included in each of sensors in a detection system that detects an object by using the sensors. The control system includes: a counter that generates an operation signal for causing a corresponding one of the sensors to operate in accordance with a counter value; a first obtainer that obtains time information that is shared among the sensors; a second obtainer that obtains the counter value of the counter at a time point when the first obtainer obtains the time information; and a processing section. Based on the time information obtained by the first obtainer and the counter value obtained by the second obtainer, the processing section performs adjustment processing for adjusting a timing at which the operation signal is generated.

A control method according to an aspect of the present disclosure is a control method that is performed by each of sensors in a detection system that detects an object by using the sensors. The control method includes: obtaining time information that is shared among the sensors; obtaining, at a time point when the time information is obtained, a counter value of a counter that generates an operation signal for causing a corresponding one of the sensors to operate in accordance with the counter value; and based on the time information obtained and the counter value obtained, performing adjustment processing for adjusting a timing at which the operation signal is generated.

### Advantageous Effects

A control system or the like according to an aspect of the present disclosure has an advantage in that the operation timing of a sensor can be adjusted without wiring a signal line for timing adjustment.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for explaining a case where operations of sensors interfere with each other.

FIG. 2 is a diagram for explaining a case where operations of sensors do not interfere with each other.

FIG. 3 is a diagram for explaining an arrangement of sensors according to a comparative example.

FIG. 4 is a schematic diagram illustrating an overall configuration including a control system according to an embodiment.

FIG. 5 is a diagram for explaining an example of an operation of a counter according to the embodiment.

FIG. 6 is a schematic diagram illustrating an example of an operation of the control system according to the embodiment.

FIG. 7 is a flowchart showing an example of an operation of the control system according to the embodiment.

FIG. 8 is a diagram illustrating an example of a program related to adjustment processing performed by the control system according to the embodiment.

FIG. 9 is a diagram illustrating an example of operations of sensors when there is no difference in count between counters.

FIG. 10 is a diagram illustrating an example of operations of sensors when there is a difference in count between counters.

FIG. 11 is a diagram illustrating an example of adjustment of the operation timing of a sensor when there is a difference in count between counters.

FIG. 12 is a schematic diagram illustrating an overall configuration including a control system according to a variation of the embodiment.

FIG. 13 is a schematic diagram illustrating an overall configuration including a control system according to another variation of the embodiment.

### DESCRIPTION OF EMBODIMENT

### Underlying Knowledge Leading to the Present Disclosure

For example, a system that detects an object by using sensors, such as time of flight (TOF) cameras, for detecting the object has been known. In such a system that detects an object by using sensors, the accuracy of detecting an object is decreased due to interference among the sensors. Here, when each of the sensors is a TOF camera, “interference” means a state in which light emitted by another sensor other than the sensor is received.

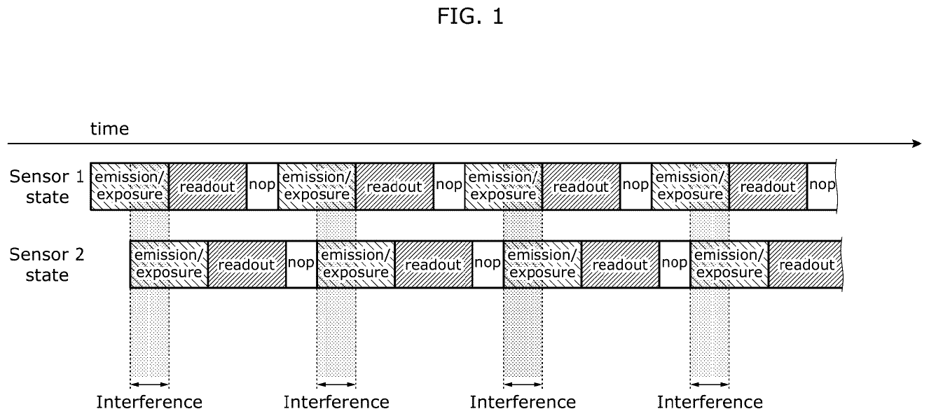

FIG. 1 is a diagram for explaining a case where operations of sensors interfere with each other. In FIG. 1, “Sensor 1 state” represents a state of one of two sensors (here, two TOF cameras), and “Sensor 2 state” represents a state of the other of the two sensors. Moreover, in FIG. 1, “emission/exposure” represents a light emission and exposure period of a sensor, “readout” represents a period in which image data is read out from a sensor, and “nop” represents a standby period. In the example illustrated in FIG. 1, the light emission and exposure period of “Sensor 1” and the light emission and exposure period of “Sensor 2” overlap with each other, and the operation of “Sensor 1” and the operation of “Sensor 2”interfere with each other.

In the example illustrated in FIG. 1, for example, a correct distance measurement result cannot be achieved since “Sensor 1” receives not only light that corresponds to own light emission and has been reflected from the object but also light that corresponds to light emission of “Sensor 2” and has been reflected from the object. The same situation that occurs in “Sensor 1” also occurs in “Sensor 2”.

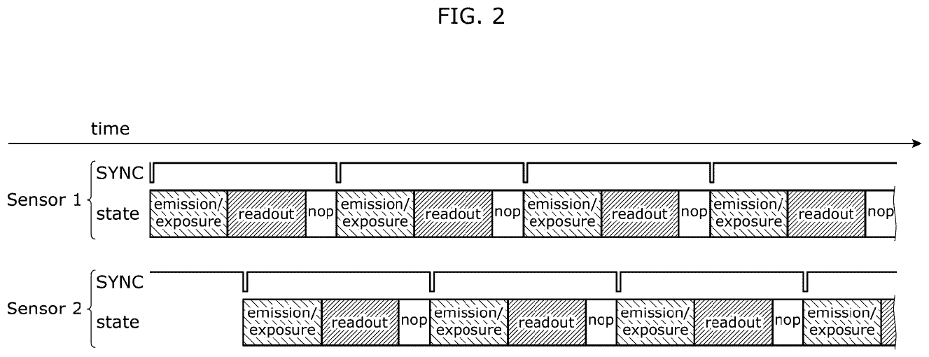

As a method for solving the above-described situation, it is conceivable to temporally shift the operation timings of the sensors from each other by providing a synchronization signal to each of the sensors to synchronize the sensors, for example. FIG. 2 is a diagram for explaining a case where operations of sensors do not interfere with each other. In FIG. 2, “SYNC” represents a synchronization signal. It should be noted that the description for a point common to FIG. 1 is omitted in FIG. 2.

In the example illustrated in FIG. 2, each of “Sensor 1” and “Sensor 2” operates so that a light emission and exposure period starts at a timing when the synchronization signal falls, and the timing is temporally different between the sensors. Accordingly, in the example illustrated in FIG. 2, the above-described situation does not occur since the light emission and exposure period of “Sensor 1” and the light emission and exposure period of “Sensor 2” do not overlap with each other, and the operation of “Sensor 1” and the operation of “Sensor 2” do not interfere with each other.

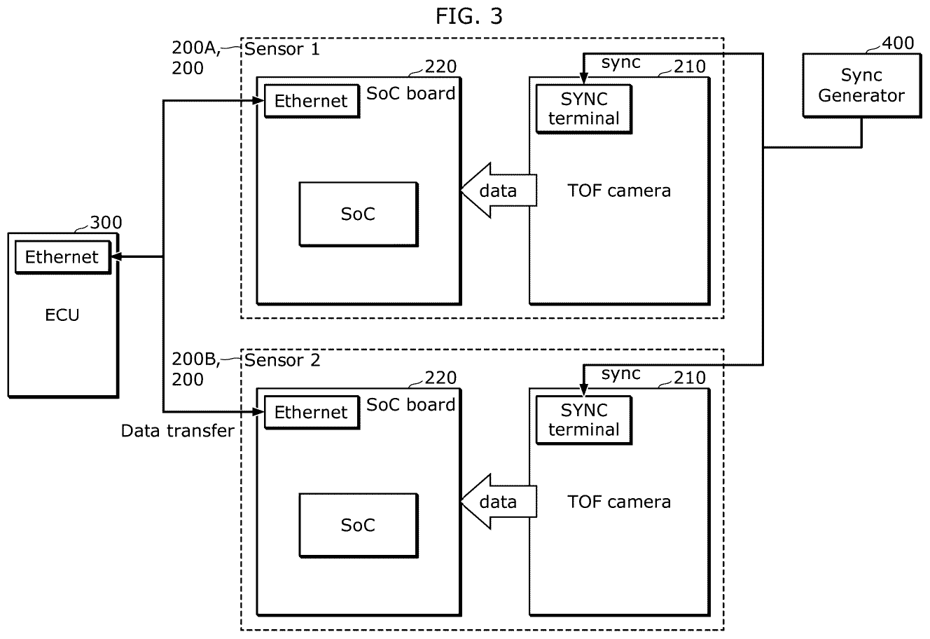

Here, as a method for providing a synchronization signal to each sensor, it is conceivable to connect each sensor and a single device, such as a sync generator, via a dedicated line and transmit a synchronization signal to each sensor via the dedicated line as illustrated in FIG. 3, and such a method requires the following arrangement, for example.

FIG. 3 is a diagram for explaining an arrangement of sensors 200 according to a comparative example. In FIG. 3, there are two sensors 200 according to the comparative example, and sensor 200A that is one of the two sensors is also referred to as “Sensor 1” and sensor 200B that is the other of the two sensors is also referred to as “Sensor 2”. Each sensor 200 includes functional unit 210 that functions as a TOF camera, and processing unit 220 that processes image data from functional unit 210 and then transmits the image data to electronic control unit (ECU) 300. Processing unit 220 is configured as a system-on-chip (SoC) board, for example. ECU 300 performs various processes based on data (a result of detecting an object) transmitted from each sensor 200.

In the comparative example, sensor 200A and sensor 200B are each connected via a dedicated line to sync generator 400 that generates a synchronization signal (“sync” in FIG. 3), and are synchronized by the synchronization signal transmitted from sync generator 400. Thus, in the comparative example, a dedicated line needs to be wired from sync generator 400 to each sensor 200. Therefore, for example, depending on the relative positional relationship between sync generator 400 and each sensor 200, wiring of a dedicated line may become difficult and an installation position of each sensor 200 may be limited. Moreover, for example, wiring is troublesome since the number of dedicated lines to be wired increases as the number of sensors 200 increases.

In view of the above-described points, the present disclosure provides a control system or the like that can synchronize sensors without wiring the above-described dedicated line, in other words, that can adjust the operation timing of each sensor without wiring a signal line for timing adjustment.

### Embodiment

Hereinafter, an embodiment will be specifically described with reference to the Drawings.

It should be noted that the embodiment described below shows a general or specific example. The numerical values, shapes, materials, constituent elements, the arrangement and connection of the constituent elements, steps, the processing order of the steps etc. shown in the following embodiment is a mere example, and therefore is not intended to limit the scope of the present disclosure.

### Configuration

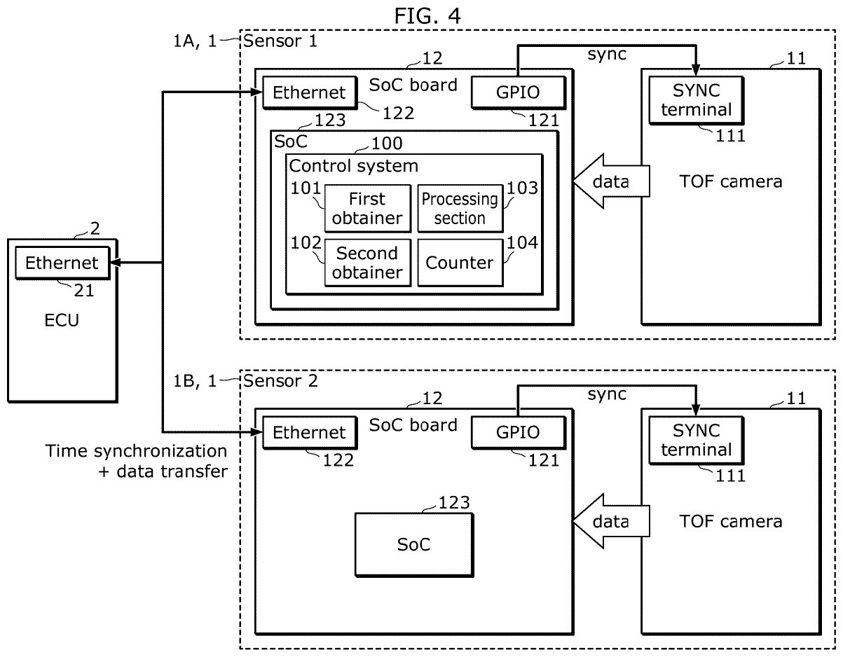

Hereinafter, a configuration of a control system according to the embodiment will be described with reference to FIG. 4. FIG. 4 is a schematic diagram illustrating an overall configuration including control system 100 according to the embodiment. In the embodiment, control system 100 is used for a detection system that detects an object by using sensors (here, two sensors) 1, and is installed in each of sensors 1. Hereinafter, when distinguishing between two sensors 1, one of two sensors 1 is referred to as sensor 1A (or “Sensor 1”) and the other of two sensors 1 is referred to as sensor 1B (or “Sensor 2”). It should be noted that control system 100 can also be used for a detection system that includes three or more sensors 1.

In the embodiment, each of sensors 1 is a TOF camera. Each of sensors 1 includes functional unit 11 that functions as the TOF camera and processing unit 12 that processes image data from functional unit 11 and then transmits the image data to ECU 2. Functional unit 11 and processing unit 12 are connected to each other by internal wiring. It should be noted that unlike the above-described dedicated line, the internal wiring is provided inside each of sensors 1 and is not connected to an external device such as a sync generator.

Functional unit 11 includes terminal 111. Terminal 111 is connected to first terminal 121 (to be described later) of processing unit 12 via the internal wiring, and receives an operation signal (“sync” in FIG. 4) transmitted from processing unit 12.

Here, an operation signal is a signal for counter 104 (to be described later) to cause a corresponding one of sensors 1 to operate in accordance with a counter value. For example, counter 104 included in sensor 1A (“Sensor 1”) generates an operation signal for causing sensor 1A to operate. Moreover, for example, counter 104 included in sensor 1B (“Sensor 2”) generates an operation signal for causing sensor 1B to operate. In the embodiment, an operation signal is a falling pulse that occurs at a timing when a corresponding one of sensors 1 is caused to operate.

Functional unit 11 operates at a timing in accordance with an operation signal received via terminal 111. Specifically, each time functional unit 11 receives a falling pulse that is an operation signal, functional unit 11 starts light emission and exposure, and then performs a set of processes of reading out image data and transmitting the image data to processing unit 12.

Processing unit 12 is configured as a SoC board, and includes first terminal 121, second terminal 122, and SoC 123.

First terminal 121 is a general-purpose input/output (GPIO) terminal and is connected to terminal 111 of functional unit 11 via the internal wiring. First terminal 121 transmits, to terminal 111 of functional unit 11, an operation signal generated by counter 104 (to be described later) of SoC 123.

Second terminal 122 is a terminal for wired communication in conformity with the Ethernet standard, and is connected to terminal 21 of ECU 2 via an Ethernet cable. Second terminal 122 transmits, to terminal 21 of ECU 2, data (a result of detecting an object) processed by SoC 123. Moreover, second terminal 122 receives time information (to be described later) transmitted from ECU 2.

When ECU 2 receives data (a result of detecting an object) transmitted from each of sensors 1 via terminal 21, ECU 2 performs various processes based on the data received from each of sensors 1. Moreover, ECU 2 transmits time data to each of sensors 1 via terminal 21. In the embodiment, time data is synchronized time data received by ECU 2 from a network time protocol (NTP) server, for example. Accordingly, sensors 1 can share synchronized time by receiving the time data transmitted from ECU 2.

SoC 123 performs various processes of sensor 1. SoC 123 includes a computer including a processor, a memory, etc. The memory is a read only memory (ROM), a random-access memory (RAM), or the like, and can store a program that is executed by the processor. In the embodiment, control system 100 is realized by the processor or the like that executes the program stored in the memory of SoC 123. Control system 100 includes first obtainer 101, second obtainer 102, processing section 103, and counter 104.

First obtainer 101 obtains time information shared among sensors 1. In the embodiment, each of sensors 1 receives time data periodically transmitted from ECU 2 via second terminal 122, and measures the current time by a timer using, as a reference, the time data received. Then, first obtainer 101 obtains, as time information, the current time measured. Here, the time data received by each of sensors 1 is synchronized time data as described above. Accordingly, the current time obtained by first obtainer 101 is generally the same among sensors 1.

Second obtainer 102 obtains the counter value of counter 104 at a time point when first obtainer 101 obtains the time information, that is, the counter value at the current time. In the embodiment, as described later, counter 104 increments the counter value from “0” every clock, and resets the counter value when the counter value reaches a first comparison value (COMPARE 1). Accordingly, second obtainer 102 obtains the counter value in a range from 0 to the first comparison value.

Processing section 103 includes a central processing unit (CPU). It should be noted that processing section 103 may include, for example, an application specific integrated circuit (ASIC), a field programmable gate array (FPGA), or the like, instead of a CPU.

Based on the time information obtained by first obtainer 101 and the counter value obtained by second obtainer 102, processing section 103 performs adjustment processing for adjusting a timing at which an operation signal is generated. In the embodiment, processing section 103 performs the adjustment processing each time processing section 103 receives an interrupt signal (to be described later) transmitted from counter 104. The adjustment processing will be described in detail in <Operation> below.

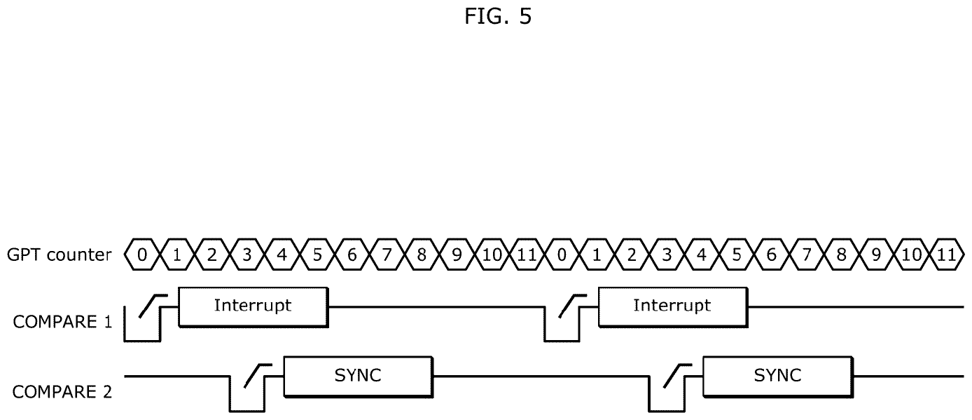

Counter 104 is, for example, a generic timer such as a general-purpose timer (GPT), and generates an operation signal for causing a corresponding one of sensors 1 to operate in accordance with the counter value. Hereinafter, a specific example of an operation of counter 104 will be described with reference to FIG. 5.

FIG. 5 is a diagram for explaining an example of an operation of counter 104 according to the embodiment. In FIG. 5, “GPT counter” represents the counter value measured by counter 104, “COMPARE 1” represents a timing when the counter value reaches a first comparison value, and “COMPARE 2” represents a timing when the counter value reaches a second comparison value.

In the example illustrated in FIG. 5, the first comparison value is set to “11” (COMPARE 1=11), and the second comparison value is set to “2” (COMPARE 2=2). The first comparison value is set in common for sensors 1. Meanwhile, the second comparison value is set differently for each of sensors 1. Specifically, the second comparison value is set differently for each of sensors 1 so that the operation timings (here, light emission and exposure starting timings) of sensors 1 do not overlap with each other.

As illustrated in FIG. 5, counter 104 increments the counter value from “0” every clock. Then, when the counter value reaches the first comparison value (here, COMPARE 1=11), counter 104 generates an interrupt signal (“Interrupt” in FIG. 5) and transmits the interrupt signal generated to processing section 103. Processing section 103 performs adjustment processing when receiving the interrupt signal transmitted from counter 104. Moreover, when the counter value reaches the first comparison value, counter 104 resets the counter value to “0”.

Furthermore, as illustrated in FIG. 5, when the counter value reaches the second comparison value (here, COMPARE 2=2), counter 104 generates a falling pulse (“sync” in FIG. 5) as an operation signal. As described above, since the counter value is reset each time the counter value reaches the first comparison value, counter 104 generates an operation signal in a predetermined cycle (here, COMPARE 1 (=11)+1=12 clocks).

### Operation

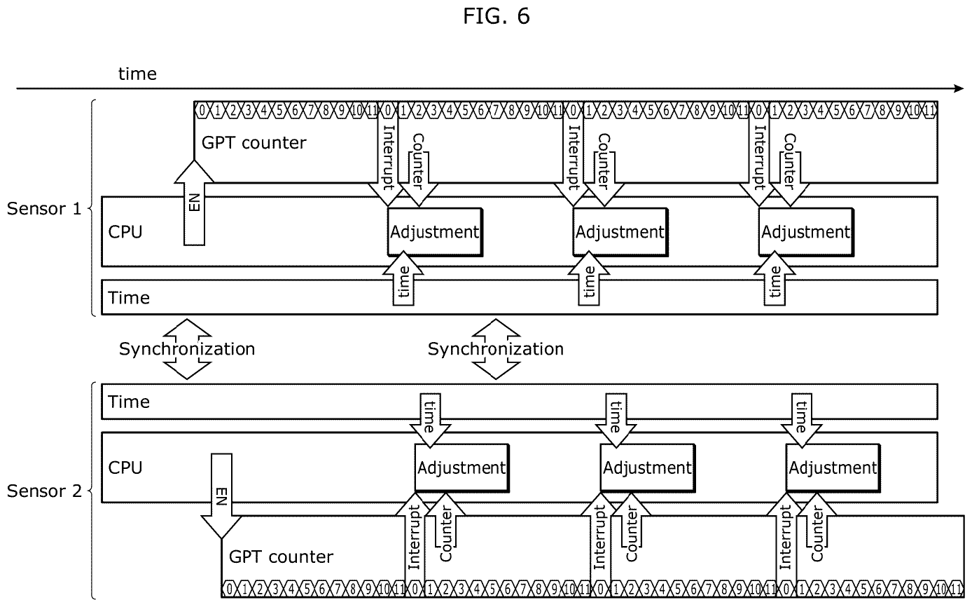

Hereinafter, an example of an operation of control system 100 according to the embodiment will be described with reference to the Drawings. FIG. 6 is a schematic diagram illustrating an example of an operation of control system 100 according to the embodiment. In the example illustrated in FIG. 6, “CPU” represents processing section 103 of control system 100, and “GPT counter” represents counter 104 of control system 100. Moreover, in the example illustrated in FIG. 6, “EN” represents an enable signal for activating counter 104, and “Interrupt” represents an interrupt signal. Furthermore, in the example illustrated in FIG. 6, “time” shown in an arrow mark represents time information, and “Counter”represents a counter value.

In the example illustrated in FIG. 6, there is a difference in counter value between counter 104 in sensor 1A (“Sensor 1”) and counter 104 in sensor 1B (“Sensor 2”). This difference is due to the fact that a timing at which counter 104 in sensor 1A is activated and a timing at which counter 104 in sensor 1B is activated is different from each other, and it is difficult to synchronize these timings. Then, each time an interrupt signal is received, control system 100 according to the embodiment obtains time information and the counter value of counter 104 at a time point when the time information is obtained, and performs, based on them, adjustment processing for adjusting a timing at which an operation signal is generated.

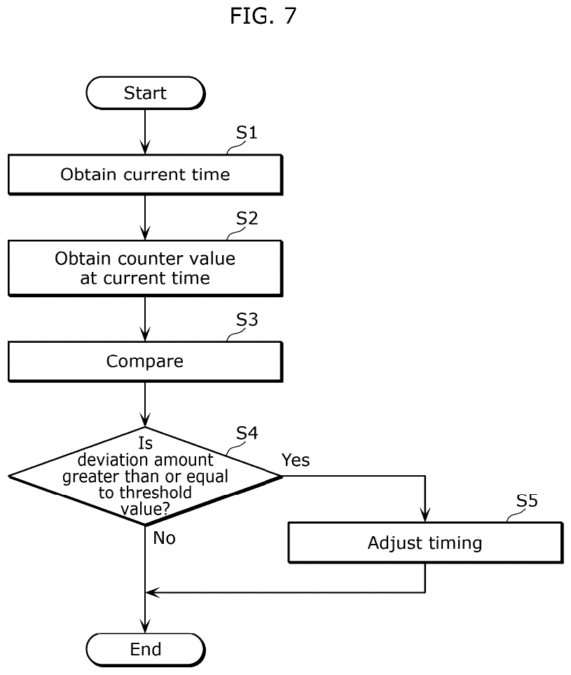

FIG. 7 is a flowchart showing an example of an operation of control system 100 according to the embodiment, and specifically, a flowchart showing an example of adjustment processing performed by control system 100. The adjustment processing illustrated in FIG. 7 is performed each time processing section 103 receives an interrupt signal transmitted from counter 104.

First, first obtainer 101 of control system 100 obtains the current time as time information (S1). Next, second obtainer 102 of control system 100 obtains the counter value of counter 104 at a time point when first obtainer 101 obtains the time information, that is, the counter value at the current time (S2).

Next, processing section 103 of control system 100 compares the time information obtained by first obtainer 101 with the counter value of counter 104 obtained by second obtainer 102 (S3). Specifically, processing section 103 converts, to a counter value, the time information (current time) obtained by first obtainer 101, and calculates a difference between the counter value obtained by converting the time information and the counter value at the current time obtained by second obtainer 102. Then, based on the difference calculated, processing section 103 calculates a deviation amount of the counter value of counter 104. Here, the deviation amount is a value obtained by converting, to the number of counts, a delay time of counter 104 relative to the current time shared among sensors 1.

Next, processing section 103 compares the deviation amount calculated with a threshold value set in advance, and when the deviation amount is less than the threshold value (S4: No), processing section 103 terminates the adjustment processing without adjusting a timing at which an operation signal is generated. In contrast, when the deviation amount is greater than or equal to the threshold value (S4: Yes), processing section 103 adjusts a timing at which an operation signal is generated according to the deviation amount (S5) and then terminates the adjustment processing.

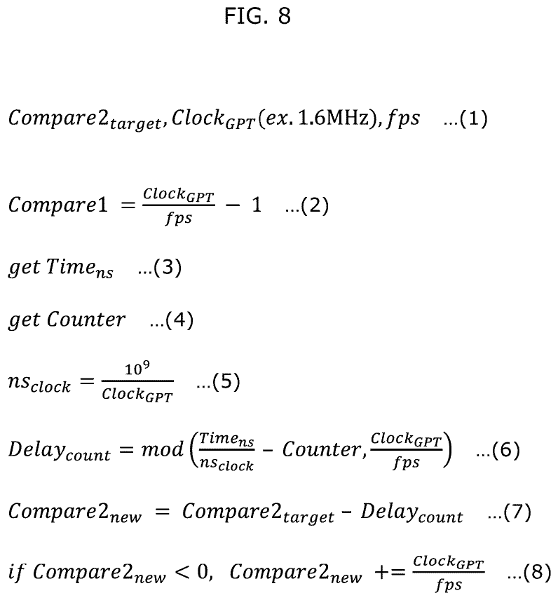

FIG. 8 is a diagram illustrating an example of a program related to the adjustment processing performed by control system 100 according to the embodiment. Among processes (1) to (8) described below, processes (1) and (2) are preliminary processes that are performed before processing section 103 performs the adjustment processing, and it is sufficient for them to be performed only once basically. Moreover, among processes (1) to (8) described below, processes (3) to (8) are processes that are performed each time processing section 103 receives an interrupt signal.

Process (1) is a process for setting a target value (Compare2_{target}) of a second comparison value, a clock frequency (Clock_{GPT}) of counter 104, and a frame rate (fps) of counter 104. The clock frequency of counter 104 is, for example, 1.6 MHz. It should be noted that it is not necessary to perform process (1) if default values are set at the time of designing control system 100.

Process (2) is a process for setting a first comparison value (Compare1). As indicated by the equation of process (2), a first comparison value is calculated by subtracting 1 from the number of clocks per frame (=Clock_{GPT}/fps) of counter 104.

Process (3) is a process for obtaining time information (Timeₙₛ). Process (3) corresponds to step S1 in FIG. 7. Here, time information is the current time, and the unit of time information is nanosecond.

Process (4) is a process for obtaining the counter value (Counter) of counter 104 at a time point when the time information is obtained, that is, at the current time. Process (4) corresponds to step S2 in FIG. 7.

Process (5) is a process for calculating time per clock (ns_{clock}). It should be noted that process (5) may be performed only in initial adjustment processing and need not be performed in the subsequent adjustment processing, for example. Moreover, process (5) may be a preliminary process, similar to processes (1) and (2).

Process (6) is a process for calculating a delay time (Delay_{count}). As indicated by the equation of process (6), a delay time is calculated as a remainder obtained when the counter value (Counter) of counter 104 at the current time is subtracted from a counter value obtained by converting the current time (=Timeₙₛ/ns_{clock}) to calculate a difference between the counter values and then the difference is divided by the number of clocks per frame (=ClockGPT/fps) of counter 104. Process (6) corresponds to step S3 in FIG. 7.

Process (7) is a process for updating the second comparison value, that is, a process for updating a timing at which an operation signal is generated. As indicated by the equation of process (7), a post-update second comparison value (Compare2_{new}) is calculated by subtracting the delay time (Delay_{count}) from the pre-update second comparison value (Compare2_{target}). Process (7) corresponds to step S5 in FIG. 7. In other words, process (7) is performed when the deviation amount (delay time (Delay_{count})) is greater than or equal to a threshold value.

Process (8) is performed when the post-update second comparison value (Compare2_{new}) calculated in process (7) is a negative value. Here, the second comparison value is represented by the counter value of counter 104. Then, as described above, the counter value of counter 104 is represented by a positive value in a range from 0 to the first comparison value. Accordingly, when the post-update second comparison value is a negative value, the post-update second comparison value is adjusted to fall within the range from 0 to the first comparison value by adding the number of clocks per frame (=ClockGPT/fps) to the post-update second comparison value.

Hereinafter, a specific example of adjustment of the operation timing of sensor 1 performed by control system 100 according to the embodiment will be described with reference to the Drawings. Hereinafter, the description will be given on the premise that the second comparison value (COMPARE 2) in counter 104 of sensor 1A (“Sensor 1”) is set to “2” in advance and the second comparison value in counter 104 of sensor 1B (“Sensor 2”) is set to “8” in advance.

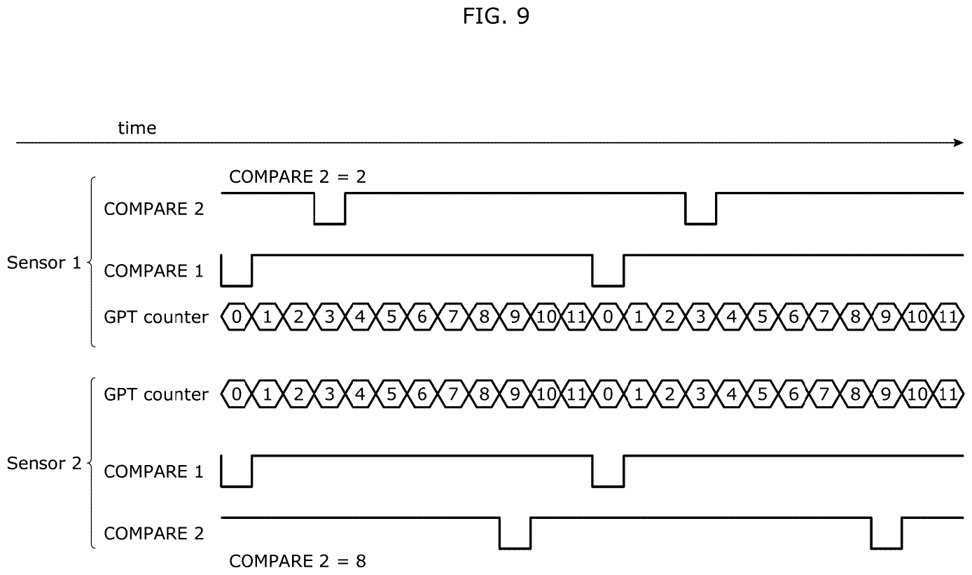

FIG. 9 is a diagram illustrating an example of operations of sensors 1 when there is no difference in count between counters 104. In the example illustrated in FIG. 9, there is no difference in count between counter 104 of sensor 1A and counter 104 of sensor 1B. Accordingly, since there is a sufficient interval (here, five clocks) between a timing at which sensor 1A generates an operation signal and a timing at which sensor 1B generates an operation signal, sensor 1A and sensor 1B can operate without interfering with each other.

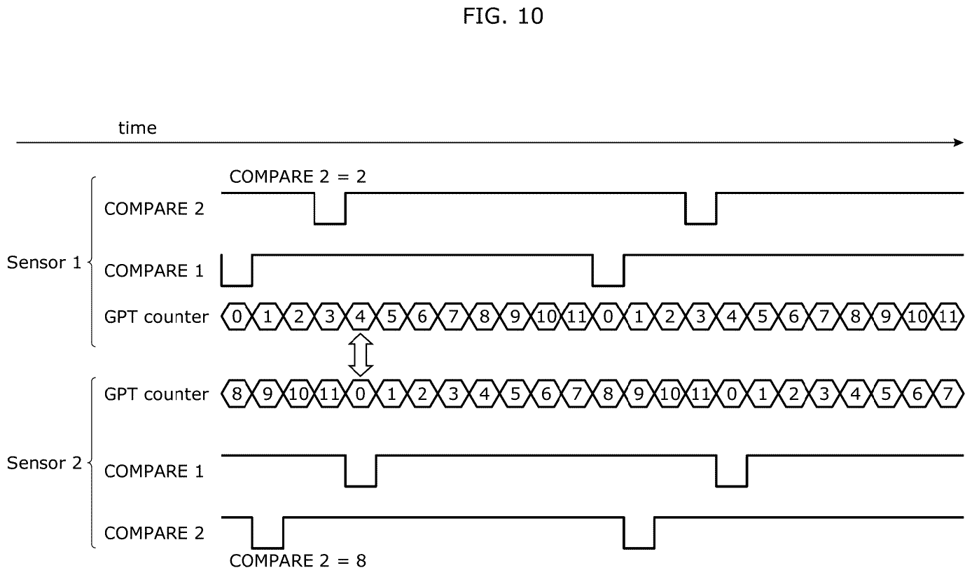

FIG. 10 is a diagram illustrating an example of operations of sensors 1 when there is a difference in count between counters 104. In the example illustrated in FIG. 10, counter 104 of sensor 1B is delayed by four clocks relative to counter 104 of sensor 1A. In this case, the operation timing of sensor 1B is delayed by four clocks relative to what it would be in a case where there is no difference in count between counters 104. Accordingly, there is only one clock between a timing at which sensor 1A generates an operation signal and a timing at which sensor 1B generates an operation signal, and there is a possibility that sensor 1A and sensor 1B operate while interfering with each other.

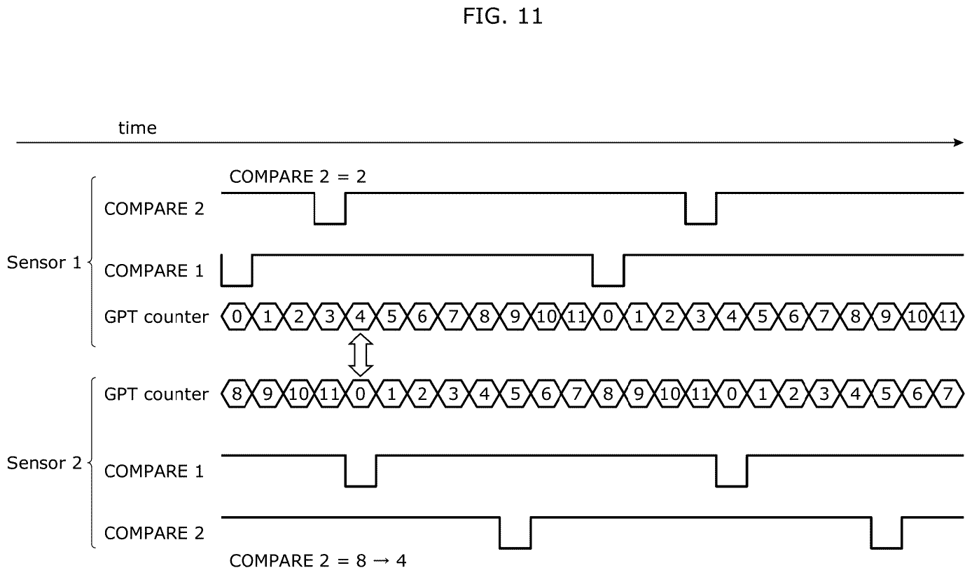

FIG. 11 is a diagram illustrating an example of adjustment of the operation timing of sensor 1 when there is a difference in count between counters 104. In the example illustrated in FIG. 11, processing section 103 of sensor 1B performs adjustment processing to adjust the second comparison value (COMPARE 2) from “8” to “4”. In this case, the operation timing of sensor 1B is the same as what it would be in a case where there is no difference in count between counters 104. Accordingly, since there is a sufficient interval (here, five clocks) between a timing at which sensor 1A generates an operation signal and a timing at which sensor 1B generates an operation signal, sensor 1A and sensor 1B can operate without interfering with each other, similar to a case where there is no difference in count between counters 104 of sensors 1A and 1B.

### Advantage

Hereinafter, an advantage of control system 100 according to the embodiment will be described. As described above, based on time information shared among sensors 1 and the counter value of counter 104 at a time point when the time information is obtained, control system 100 according to the embodiment adjusts a timing at which an operation signal is generated. Therefore, in control system 100 according to the embodiment, by using, as a reference, time information that is equivalent to that synchronized among sensors 1, it is possible to perform adjustment processing for adjusting the operation timing of sensor 1 to a timing that is equivalent to what it would be in a case where there is no difference in count between counters 104. Accordingly, control system 100 according to the embodiment has an advantage in that the operation timing of a sensor can be adjusted without wiring a signal line for timing adjustment.

In particular, in control system 100 according to the embodiment, processing section 103 performs adjustment processing so that operation periods of sensors 1 do not overlap with each other. Therefore, control system 100 according to the embodiment has an advantage in that the operation periods of sensors 1 do not overlap with each other and sensors 1 are likely to operate without interfering with each other.

Moreover, control system 100 according to the embodiment has an advantage in that since a dedicated line for synchronizing sensors 1 need not be wired, a situation in which wiring becomes difficult depending on the positional relationship between sensors 1 as described in the comparative example does not occur and a degree of freedom of installation position of each sensor 1 can be improved. Furthermore, control system 100 according to the embodiment has an advantage in that since a dedicated line need not be wired as described above, a situation in which wiring of a dedicated line becomes troublesome as the number of sensors 1 increases as described in the comparative example does not occur.

### Other Embodiments

Hereinabove, a control system according to an aspect of the present disclosure has been described based on the embodiment; however, the present disclosure is not limited to the above-described embodiment. Forms obtained by various modifications to the above-described embodiment that can be conceived by a person skilled in the art as well as forms realized by combining constituent elements in the embodiment may be included within an aspect of the present disclosure, as long as they do not depart from the essence of the present disclosure.

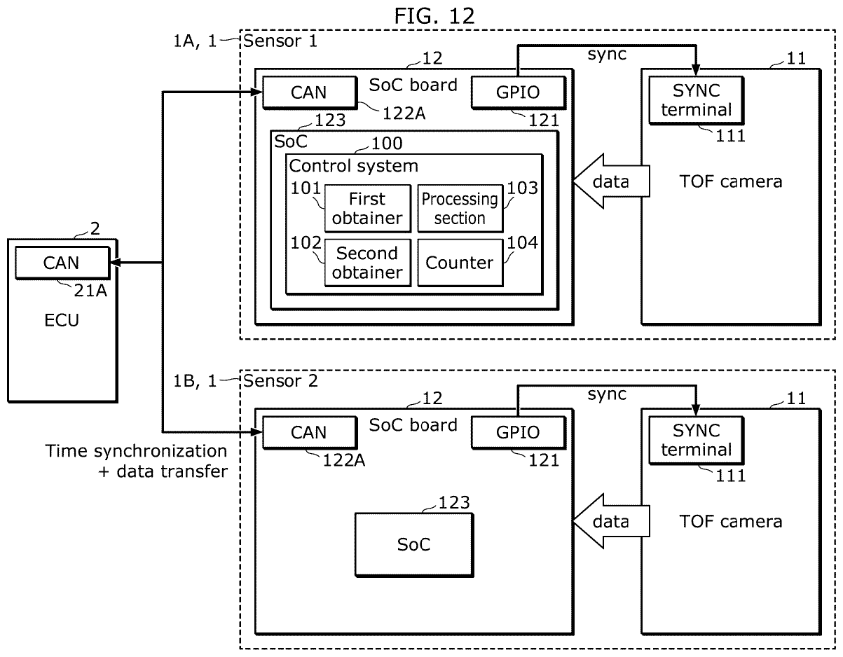

FIG. 12 is a schematic diagram illustrating an overall configuration including control system 100 according to a variation of the embodiment. The example illustrated in FIG. 12 is different from the above-described embodiment in that each sensor 1 and ECU 2 in the example illustrated in FIG. 12 do not perform wired communication in conformity with the Ethernet standard but perform wired communication in conformity with the controller area network (CAN) standard. Specifically, instead of second terminal 122, each sensor 1 includes second terminal 122A that is a terminal for wired communication in conformity with the CAN standard, and, instead of terminal 21, ECU 2 includes terminal 21A that is a terminal for wired communication in conformity with the CAN standard.

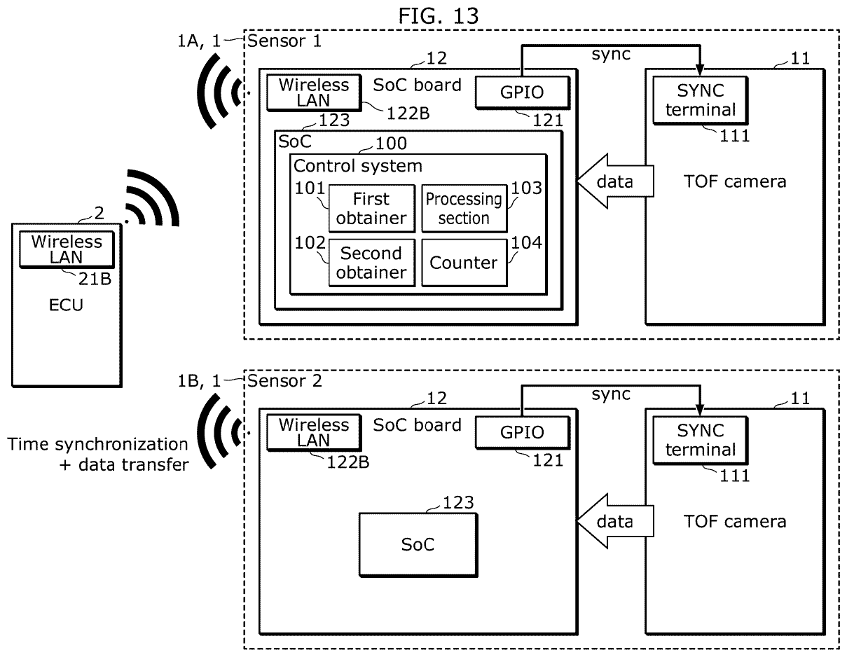

FIG. 13 is a schematic diagram illustrating an overall configuration including control system 100 according to another variation of the embodiment. The example illustrated in FIG. 13 is different from the above-described embodiment in that each sensor 1 and ECU 2 in the example illustrated in FIG. 13 do not perform wired communication but perform wireless communication in conformity with the wireless local area network (LAN) standard. Specifically, instead of second terminal 122, each sensor 1 includes second terminal 122B that is a terminal for wireless communication in conformity with the wireless LAN standard, and, instead of terminal 21, ECU 2 includes terminal 21B that is a terminal for wireless communication in conformity with the wireless LAN standard.

For example, in the embodiment, when a deviation amount calculated in adjustment processing is greater than or equal to a threshold value, processing section 103 of control system 100 adjusts the operation timing of sensor 1 regardless of how much the deviation amount is. However, the present disclosure is not limited to this example. For example, when a deviation amount calculated is greater than or equal to a permissible value, processing section 103 may adjust the operation timing of sensor 1 based on the permissible value. For example, when the permissible value is five clocks and the deviation amount calculated is eight clocks, processing section 103 may adjust the operation timing by five clocks that is the permissible value, instead of adjusting the operation timing by eight clocks.

Moreover, for example, processing section 103 may adjust the operation timing of sensor 1 based on a value less than a deviation amount calculated. For example, when a deviation amount calculated is eight clocks, processing section 103 may adjust the operation timing by one clock or more and less than eight clocks, such as four clocks that is half of eight clocks, instead of adjusting the operation timing by eight clocks.

For example, although time information shared among sensors 1 is the current time in the embodiment, the present disclosure is not limited to this example. For example, it is sufficient if time information shared among sensors 1 is a parameter that increases monotonically over time.

For example, although each of sensors 1 is a TOF camera in the embodiment, the present disclosure is not limited to this example. For example, it is sufficient if each of sensors 1 is a sensor that can detect an object by emitting a medium used for detection, such as light or sound.

For example, in the embodiment, processing section 103 of control system 100 performs adjustment processing so that operation periods of sensors 1 do not overlap with each other. However, the present disclosure is not limited to this example. For example, in a case where sensors 1 are caused to operate at the same time or the like, processing section 103 may perform adjustment processing so that sensors 1 operate in the same period.

For example, although control system 100 is realized by SoC 123 in each sensor 1 in the embodiment, the present disclosure is not limited to this example. For example, control system 100 may be realized by a circuit other than SoC 123 in each sensor 1.

For example, the present disclosure can be realized not only as a control system but also as a control method that includes a step (process) performed by the constituent elements included in the control system.

The control method is a method performed by the control system. For example, as illustrated in FIG. 7, the control method is a control method performed by each of sensors in a detection system that detects an object by using the sensors, and the control method includes: performing a process for obtaining time information shared among the sensors (step S1); performing a process for obtaining, at a time point when the time information is obtained, a counter value of a counter that generates an operation signal for causing a corresponding one of the sensors to operate in accordance with the counter value (step S2); and performing, based on the time information obtained and the counter value obtained, adjustment processing for adjusting a timing at which the operation signal is generated (steps S3 to S5).

For example, the present disclosure can be realized as a program for causing a computer (processor) to perform the steps included in the control method. The processor may be a single processor or include a plurality of processors. Moreover, the present disclosure can be realized as a non-transitory computer-readable recording medium, such as a CD-ROM, having the program recorded thereon.

For example, when the present disclosure is realized as a program (software), each step is performed by executing the program using a hardware resource, such as a CPU, a memory, or an input/output circuit, of a computer. In other words, each step is performed by, for example, a CPU obtaining data from a memory, an input/output circuit, etc. to perform calculation and outputting a result of the calculation to the memory, the input/output circuit, etc.

It should be noted that, in the above-described embodiment, each constituent element included in the control system may be configured by dedicated hardware or realized by performing a software program suitable for the constituent element. Each constituent element may be realized by a program executor, such as a CPU or a processor, reading out and executing a software program recorded on a recording medium such as a hard disk, a semiconductor memory, etc.

A portion or all of the functions of the control system according to the above-described embodiment is typically realized as large-scale integration (LSI) that is an integrated circuit. Each of the functions may be individually realized as a single chip, or a portion or all of the functions may be realized as a single chip. Moreover, circuit integration is not limited to LSI and may be realized by dedicated circuits or generic processors. It is possible to use: a field programmable gate array (FPGA) that is programmable after manufacturing of LSI; or a reconfigurable processor whose connections and settings regarding circuit cells in the LSI are reconfigurable.

### Note

The techniques shown below are disclosed by the description of the above-described embodiment.

### Technique 1

A control system is included in each of sensors in a detection system that detects an object by using the sensors. The control system includes: a counter that generates an operation signal for causing a corresponding one of the sensors to operate in accordance with a counter value; a first obtainer that obtains time information that is shared among the sensors; a second obtainer that obtains the counter value of the counter at a time point when the first obtainer obtains the time information; and a processing section. Based on the time information obtained by the first obtainer and the counter value obtained by the second obtainer, the processing section performs adjustment processing for adjusting a timing at which the operation signal is generated.

Accordingly, by using, as a reference, time information that is equivalent to that synchronized among sensors, it is possible to perform adjustment processing for adjusting the operation timing of a corresponding one of the sensors to a timing that is equivalent to what it would be in a case where there is no difference in count between counters. Thus, there is an advantage that the operation timing of a sensor can be adjusted without wiring a signal line for timing adjustment.

### Technique 2

In the control system according to Technique 1, the processing section performs the adjustment processing to cause operation periods of the sensors not to overlap with each other.

Accordingly, there is an advantage that operation periods of sensors do not overlap with each other and the sensors are likely to operate without interfering with each other.

### Technique 3

In the control system according to Technique 1 or 2, the processing section: converts, to a counter value, the time information obtained by the first obtainer; calculates a difference between the counter value obtained by converting the time information and the counter value obtained by the second obtainer; calculates, based on the difference, a deviation amount of the counter value of the counter; and adjusts the timing based on the deviation amount calculated.

Accordingly, since the operation timing of a sensor is adjusted by calculating a deviation amount of a counter, the operation timing of the sensor is likely to be adjusted with high accuracy.

### Technique 4

In the control system according to Technique 3, when the deviation amount calculated is greater than or equal to a permissible value, the processing section adjusts the timing based on the permissible value.

Accordingly, there is an advantage that it is possible to suppress rapid change in the behavior of a sensor that may occur when the operation timing of the sensor is adjusted based on a deviation amount greater than or equal to a permissible value.

### Technique 5

In the control system according to Technique 1 or 2, the processing section: converts, to a counter value, the time information obtained by the first obtainer; calculates a difference between the counter value obtained by converting the time information and the counter value obtained by the second obtainer; calculates, based on the difference, a deviation amount of the counter value relative to a reference counter value of the counter; and adjusts the timing based on a value less than the deviation amount calculated.

Accordingly, there is an advantage that it is possible to suppress rapid change in the behavior of a sensor since the operation timing of the sensor can be gradually adjusted.

### Technique 6

In the control system according to any one of Techniques 3 to 5, when the deviation amount calculated is less than a threshold value, the processing section skips adjusting the timing.

Accordingly, there is an advantage that it is possible to suppress excessively frequent adjustment of the operation timing of a sensor since transient change in a deviation amount can be ignored, for example.

### Technique 7

In the control system according to any one of Techniques 1 to 6, the counter resets the counter value when the counter value reaches a comparison value, and the processing section performs the adjustment processing each time the counter resets the counter value.

Accordingly, there is an advantage that the operation timing of a sensor is likely to be adjusted at an appropriate frequency since adjustment processing can be periodically performed according to a reset of the counter value of a counter.

### Technique 8

A control method is performed by each of sensors in a detection system that detects an object by using the sensors. The control method includes: obtaining time information that is shared among the sensors; obtaining, at a time point when the time information is obtained, a counter value of a counter that generates an operation signal for causing a corresponding one of the sensors to operate in accordance with the counter value; and based on the time information obtained and the counter value obtained, performing adjustment processing for adjusting a timing at which the operation signal is generated.

Accordingly, by using, as a reference, time information that is equivalent to that synchronized among sensors, it is possible to perform adjustment processing for adjusting the operation timing of a corresponding one of the sensors to a timing that is equivalent to what it would be in a case where there is no difference in count between counters. Accordingly, there is an advantage that the operation timing of a sensor can be adjusted without wiring a signal line for timing adjustment.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to a system or the like that detects an object by using sensors.

1. A control system that is included in each of sensors in a detection system that detects an object by using the sensors, the control system comprising:
a counter that generates an operation signal for causing a corresponding one of the sensors to operate in accordance with a counter value;
a first obtainer that obtains time information that is shared among the sensors;
a second obtainer that obtains the counter value of the counter at a time point when the first obtainer obtains the time information; and
a processing section, wherein
based on the time information obtained by the first obtainer and the counter value obtained by the second obtainer, the processing section performs adjustment processing for adjusting a timing at which the operation signal is generated.

2. The control system according to claim 1, wherein
the processing section performs the adjustment processing to cause operation periods of the sensors not to overlap with each other.

3. The control system according to claim 1, wherein
the processing section:
converts, to a counter value, the time information obtained by the first obtainer;
calculates a difference between the counter value obtained by converting the time information and the counter value obtained by the second obtainer;
calculates, based on the difference, a deviation amount of the counter value of the counter; and
adjusts the timing based on the deviation amount calculated.

4. The control system according to claim 3, wherein
when the deviation amount calculated is greater than or equal to a permissible value, the processing section adjusts the timing based on the permissible value.

5. The control system according to claim 1, wherein
the processing section:
converts, to a counter value, the time information obtained by the first obtainer;
calculates a difference between the counter value obtained by converting the time information and the counter value obtained by the second obtainer;
calculates, based on the difference, a deviation amount of the counter value relative to a reference counter value of the counter; and
adjusts the timing based on a value less than the deviation amount calculated.

6. The control system according to claim 3, wherein
when the deviation amount calculated is less than a threshold value, the processing section skips adjusting the timing.

7. The control system according to claim 1, wherein
the counter resets the counter value when the counter value reaches a comparison value, and
the processing section performs the adjustment processing each time the counter resets the counter value.

8. A control method that is performed by each of sensors in a detection system that detects an object by using the sensors, the control method comprising:
obtaining time information that is shared among the sensors;
obtaining, at a time point when the time information is obtained, a counter value of a counter that generates an operation signal for causing a corresponding one of the sensors to operate in accordance with the counter value; and
based on the time information obtained and the counter value obtained, performing adjustment processing for adjusting a timing at which the operation signal is generated.
